(19) United States
(12) Patent Application Publication
(10) Pub. No.: US 2020/0110410 A1
(43) Pub. Date: Apr. 9, 2020

(54) DEVICE AND METHOD FOR PROCESSING MAP DATA USED FOR SELF-POSITION ESTIMATION, MOBILE BODY, AND CONTROL SYSTEM FOR MOBILE BODY

(71) Applicant: Nidec Corporation, Kyoto (JP)

(72) Inventors: Takuya MURAI, Kyoto (JP); Tetsuo SAEKI, Kyoto (JP); Shinji SUZUKI, Kyoto (JP)

(21) Appl. No.: 16/589,200

(22) Filed: Oct. 1, 2019

(30) Foreign Application Priority Data
Oct. 4, 2018 (JP) 2018-189039

(51) Int. Cl. G05D 1/00; G05D 1/02

(52) U.S. Cl. CPC G05D 1/0088; G01S 17/42; G05D 1/0274; G05D 1/0212

(57) ABSTRACT

A device that processes map data used in self-position estimation of a mobile body including an external sensor, includes a processor and a memory that stores a computer program executable by the processor. The processor reads data from a storage device storing data of a two-dimensional map including a point cloud or occupied grids is stored according to a command of the computer program, extracts from the two-dimensional map one or more line segments defined by the point cloud or the occupied points on the two-dimensional map, selects at least one specific region from at least one region included in one or more line segments or at least one region defined by at least one pair of line segments, and associates additional data indicating a position of a specific region on the two-dimensional map with the data.

### CROSS REFERENCE TO RELATED APPLICATION

The present invention claims priority under 35 U.S.C. § 119 to Japanese Application No. 2018-189039 filed on Oct. 4, 2018, the entire contents of which are hereby incorporated herein by reference.

### FIELD OF THE INVENTION

The present disclosure relates to a device and a method for processing map data used for self-position estimation of a mobile body including an external sensor. The present disclosure also relates to the mobile body including the external sensor and a control system for the mobile body.

### BACKGROUND

Development of a mobile body, such as an automatic guided vehicle (automatic guided transport truck) and a mobile robot, which can move autonomously is being developed.

Conventionally, a mobile robot that performs self-position estimation by matching a local map (scan data) acquired from a laser range finder with a previously-prepared map has been disclosed.

Sometimes an environment of the mobile body includes a long passage surrounded by a flat wall surface. When the mobile body moves the long passage surrounded by the flat wall surface, the self-position estimation tends to be uncertain because the scan data acquired from the laser range finder is constituted by linear point clouds extending monotonously in one direction. When the self-position estimation is uncertain, it is difficult to stably move the mobile body.

### SUMMARY

According to an example embodiment of the present disclosure, there is provided a device that processes map data used in self-position estimation of a mobile body including an external sensor, the device including a processor and a memory that stores a computer program executable by the processor. According to a command of the computer program, the processor reads data of a two-dimensional map from a storage device in which the data of the two-dimensional map including a point cloud or a plurality of occupied grids is stored, extracts from the two-dimensional map one or a plurality of line segments defined by the point cloud or the plurality of occupied points on the two-dimensional map, selects at least one specific region from at least one region included in one or a plurality of line segments or at least one region defined by at least one pair of line segments, and associates additional data indicating a position of the specific region on the two-dimensional map with the data.

According to another example embodiment of the present disclosure, there is provided a control system that controls a mobile body including an external sensor, the control system including a processor, a memory that stores a computer program executable by the processor, and a storage device in which data of a two-dimensional map including a point cloud or a plurality of occupied grids is stored. The storage device stores additional data that is one or a plurality of line segments extracted from the two-dimensional map, the additional data indicating a position on the two-dimensional map in at least one specific region selected from at least one region defined by the point cloud or the plurality of occupied grids on the two-dimensional map or at least one region defined by at least one pair of line segments. According to a command of the computer program, the processor performs reading of the data and the additional data of the two-dimensional map from the storage device, acquiring scan data of a surrounding environment of the mobile body from the external sensor, and performing self-position estimation by matching the scan data with the data. According to a command of the computer program, the processor also performs at least one of causing the mobile body to make a detour around the specific region, decreasing a moving speed of the mobile body before the mobile body enters the specific region, decreasing or increasing the moving speed of the mobile body after the mobile body enters the specific region, and outputting a warning signal before or after the mobile body enters the specific region.

According to another example embodiment of the present disclosure, a mobile body includes the control system, the external sensor, and a drive device to generate movement.

According to another example embodiment of the present disclosure, there is provided a method implemented on a computer to process map data used in self-position estimation of a mobile body including an external sensor. The method includes reading the data from a storage device in which data of a two-dimensional map including a point cloud or a plurality of occupied grids is stored, extracting from the two-dimensional map one or a plurality of line segments defined by the point cloud or the plurality of occupied grids on the two-dimensional map, selecting at least one specific region from at least one region included in the one or the plurality of line segments defined or at least one region defined by at least one pair of line segments, and associating additional data indicating a position of the specific region on the two-dimensional map with the data.

According to another example embodiment of the present disclosure, there is provided a method implemented on a computer to control a mobile body including an external sensor. The method includes reading data of a two-dimensional map and additional data from a storage device, acquiring scan data of a surrounding environment of the mobile body from the external sensor, and performing self-position estimation by matching the scan data with the data. The additional data is a plurality of line segments extracted from the two-dimensional map and indicating a position on the two-dimensional map in at least one specific region selected from at least one region defined by a point group or a plurality of occupied grids on the two-dimensional map or at least one region defined by at least one pair of line segments. The method also includes performing at least one of causing the mobile body to make a detour around the specific region, decreasing the moving speed of the mobile body before the mobile body enters the specific region, decreasing or increasing the moving speed of the mobile body after the mobile body enters the specific region, and outputting a warning signal before or after the mobile body enters the specific region.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a view illustrating a configuration of a mobile body according to an example embodiment of the present disclosure.

FIG. 2 is a plan layout diagram schematically illustrating an example of an environment in which the mobile body moves.

FIG. 3 is a view illustrating a map of the environment in FIG. 2.

FIG. 4 is a view schematically illustrating an example of scan data SD(t) acquired by the external sensor at time t according to an example embodiment of the present disclosure.

FIG. 5A is a view schematically illustrating a state in which matching of the scan data SD(t) with a map is started.

FIG. 5B is a view schematically illustrating a state in which matching of the scan data SD(t) with the map is completed.

FIG. 6A is a view schematically illustrating a state in which a point cloud constituting the scan data rotates and translates from an initial position and approaches a point cloud on the map according to an example embodiment of the present disclosure.

FIG. 6B is a view illustrating a position and posture after a rigid transformation of the scan data.

FIG. 7 is a view schematically illustrating the mobile body located at different positions on the linearly long passage and the scan data SD(t) acquired at each position.

FIG. 8 is a view illustrating a position range of the mobile body that may erroneously be estimated.

FIG. 9 is a view illustrating a problem when the mobile body is moving in a place where a flat wall surface is present on one side of the route while an object (reflector) such as a wall does not exist on the other side.

FIG. 10 is a view illustrating a configuration example of a device that processes map data of the example embodiment of the present disclosure.

FIG. 11 is a view illustrating a two-dimensional map having the point cloud according to an example embodiment of the present disclosure.

FIG. 12 is a view schematically illustrating a state in which a virtual line segment having a certain length is extracted according to an example embodiment of the present disclosure.

FIG. 13 is a view illustrating the map to which the extracted line segment is added.

FIG. 14 is a view schematically illustrating the map data to which a specific region (hatched region) is added.

FIG. 15 is a flowchart illustrating an example of a processing procedure for extracting the line segment extraction in accordance with an example embodiment of the present disclosure.

FIG. 16 is a flowchart illustrating an example of a matching processing procedure in accordance with an example embodiment of the present disclosure.

FIG. 17 is a flowchart illustrating an example of a processing procedure for selecting a specific region in an example embodiment of the present disclosure.

FIG. 18 is a flowchart illustrating an example of operation of the mobile body of an example embodiment of the present disclosure.

FIG. 19 is a view illustrating an outline of a control system that controls traveling of each AGV (automatic guided vehicle) according to an example embodiment of the present disclosure.

FIG. 20 is a perspective view illustrating an example of an environment in which the AGV is provided.

FIG. 21 is a perspective view illustrating the AGV and a towing truck before connection.

FIG. 22 is a perspective view illustrating the AGV and the towing truck that are connected to each other.

FIG. 23 is an external view of an exemplary AGV of an example embodiment of the present disclosure.

FIG. 24A is a view illustrating an example of a first hardware configuration of the AGV according to an example embodiment of the present disclosure.

FIG. 24B is a view illustrating an example of a second hardware configuration of the AGV according to an example embodiment of the present disclosure.

FIG. 25 is a view illustrating an example of a hardware configuration of an operation management device according to an example embodiment of the present disclosure.

### DETAILED DESCRIPTION

An “automatic guided vehicle” (AGV) refers to a trackless vehicle that manually or automatically loads cargos onto the main body, travels automatically to a designated place, and manually or automatically unloads the cargos. The “automatic guided vehicle” includes an automatic guided tractor and an automatic guided forklift.

The term “automatic guided” indicates that no person is required to steer the vehicle, and does not exclude the automatic guided vehicle from transporting a “person (for example, a person who loads and unloads the cargos)”.

The “automatic guided tractor” is a trackless vehicle that travels automatically to the designated place while tows a truck that manually or automatically loads and unloads the cargos.

The “automatic guided forklift” is a trackless vehicle that includes a mast that vertically moves a cargo transfer fork, automatically transfers the cargos to the fork, travels automatically to the designated place, and performs automatic cargo handling work.

The “trackless vehicle” is a mobile body (vehicle) that includes wheels and an electric motor or engine that rotates the wheels.

The “mobile body” is a device that moves while carrying a person or a cargo, and includes a drive device, such as a wheel, a biped or multi-legged walking device, and a propeller, which generates traction for movement. The term “mobile body” in the present disclosure includes not only a narrow-sense automatic guided vehicle but also a mobile robot, a service robot, and a drone.

The “automatic traveling” includes traveling based on a command of a computer operation management system to which the automatic guided vehicle is connected by communication and autonomous traveling by a control device included in the automatic guided vehicle. The autonomous traveling includes not only traveling in which the automatic guided vehicle travels to a destination along a predetermined route, but also traveling following a tracking target. The automatic guided vehicle may temporarily perform manual traveling based on an instruction from a worker. The “automatic traveling” generally includes both “guided type” traveling and “guideless type” traveling, but refers to “guideless type” traveling in the present disclosure.

The “guided type” is a system in which an inductor is continuously or intermittently installed to guide the automatic guided vehicle using the inductor.

The “guideless type” is a system in which the automatic guided vehicle is guided without installing the inductor. The automatic guided vehicle of the example embodiment of the present disclosure includes a self-position estimation device, and can travel in a guideless manner.

The “position estimation device” is a device that estimates a self-position on a map based on sensor data acquired by an external sensor such as a laser range finder.

The “external sensor” is a sensor that senses an external state of the mobile body. Examples of the external sensor include a laser range finder (also referred to as a laser range scanner), a camera (or an image sensor), a LIDAR (Light Detection and Ranging), a millimeter wave radar, an ultrasonic sensor, and a magnetic sensor.

An “internal sensor” is a sensor that senses the state inside the mobile body. Examples of the internal sensor include a rotary encoder (hereinafter sometimes simply referred to as “encoder”), an acceleration sensor, and an angular acceleration sensor (for example, a gyro sensor).

“SLAM” is an abbreviation for “Simultaneous Localization and Mapping”, and indicates that self-location estimation and map creation are simultaneously performed.

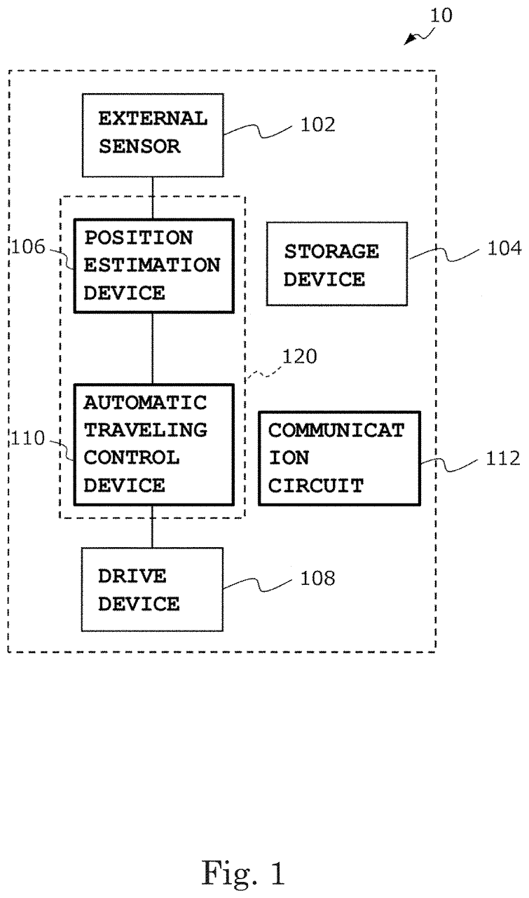

Referring to FIG. 1, a mobile body 10 of the present disclosure includes an external sensor 102 that scans an environment to periodically output scan data in an example embodiment in FIG. 1. A typical example of the external sensor 102 is a laser range finder (LRF). For example, the LRF periodically emits an infrared or visible laser beam to surroundings to scan a surrounding environment. The laser beam is reflected by a surface of a structure such as a wall and a pillar or an object placed on a floor. The LRF receives the reflected light of the laser beam, calculates a distance to each reflection point, and outputs measurement result data indicating a position of each reflection point. The position of each reflection point reflects an incoming direction and the distance of the reflected light. Sometimes the measurement result data (scan data) is referred to as “environmental measurement data” or “sensor data”.

For example, the environment is scanned by the external sensor 102 in a range of 135 degrees to the left and right (total of 270 degrees) based on a front of the external sensor 102. Specifically, a pulsed laser beam is emitted while the direction is changed at a predetermined step angle in a horizontal plane, and the reflected light of each laser beam is detected to measure the distance. The measurement data of the distance to the reflection point in the direction determined by an angle corresponding to the total of 901 steps can be obtained when the step angle is 0.3 degrees. In this example, the scan of the surrounding space performed by the external sensor 102 is substantially parallel to the floor surface and is planar (two-dimensional). However, the external sensor may perform three-dimensional scan.

A typical example of the scan data can be expressed by a position coordinate of each point constituting a point cloud acquired for each scan. The position coordinate of the point is defined by a local coordinate system that moves along with the mobile body 10. The local coordinate system can be referred to as a mobile coordinate system or a sensor coordinate system. In the present disclosure, an origin of the local coordinate system fixed to the mobile body 10 is defined as a “position” of the mobile body 10, and an orientation of the local coordinate system is defined as “posture” of the mobile body 10. Hereinafter, sometimes the position and the posture are collectively referred to as a “pose”.

When the scan data is expressed in a polar coordinate system, the scan data can be configured by a numerical set in which the position of each point is indicated by the “direction” and the “distance” from the origin in the local coordinate system. The display of the polar coordinate system can be converted into the display of an orthogonal coordinate system. In the following description, for convenience, it is assumed that the scan data output from the external sensor is displayed in the orthogonal coordinate system.

The mobile body 10 includes a storage device 104 that stores an environment map (hereinafter referred to as “map”) and a position estimation device 106. The map may be divided into a plurality of maps. The position estimation device 106 performs matching between the scan data acquired from the external sensor 102 and the map read from the storage device 104, and estimates the position and posture, namely, the pose of the mobile body 10. The matching is called pattern matching or scan matching, and can be performed according to various algorithms. A typical example of the matching algorithm is the Iterative Closest Point (ICP) algorithm.

In the illustrated example, the mobile body 10 further includes a drive device 108, an automatic traveling control device 110, and a communication circuit 112. The drive device 108 is a device that generates driving force for moving the mobile body 10. Examples of the drive device 108 include a biped or multi-legged walking device operated by a wheel (drive wheel) rotated by an electric motor or an engine, a motor or other actuator. The wheel may be an omnidirectional wheel such as a mecanum wheel. The mobile body 10 may be a mobile body that moves in air or underwater, or a hovercraft. In this case, the drive device 108 includes a propeller that is rotated by a motor.

The automatic traveling control device 110 operates the drive device 108 to control moving conditions (such as speed, acceleration, and a moving direction) of the mobile body 10. The automatic traveling control device 110 may move the mobile body 10 along a predetermined traveling route, or move the mobile body 10 according to a command provided from an outside. The position estimation device 106 calculates estimated values of the position and the posture of the mobile body 10 while the mobile body 10 is moved or stopped. The automatic traveling control device 110 refers to the estimated values to control the traveling of the mobile body 10.

The position estimation device 106 and the automatic traveling control device 110 may collectively be referred to as a traveling control device (control system) 120. The traveling control device 120 can be configured by a processor and a memory that stores a computer program controlling the operation of the processor. The processor and the memory can be configured by one or a plurality of semiconductor integrated circuits.

The communication circuit 112 is a circuit in which the mobile body 10 is connected to a communication network including an external management device, another mobile body, or a mobile terminal device of an operator to exchange data and/or a command.

A typical example of the storage device 104 is configured by a storage device that is mounted on the mobile body 10 and moves together with the mobile body 10. However, the storage device 104 is not limited to this example. The storage device 104 may be a storage device or a database that can be located outside the mobile body 10 and connected to the mobile body 10 by the communication circuit 112. When the storage device 104 is configured by the external storage device or database, a plurality of mobile bodies can appropriately read necessary map data from the common storage device 104.

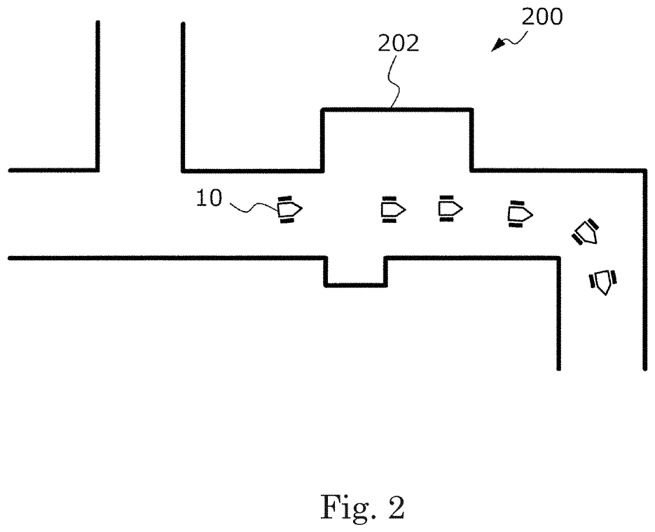

FIG. 2 is a plan layout diagram schematically illustrating an example of an environment 200 in which the mobile body 10 moves. The environment 200 is a part of a wider environment. In FIG. 2, a bold straight line indicates a fixed wall 202 of a building, for example.

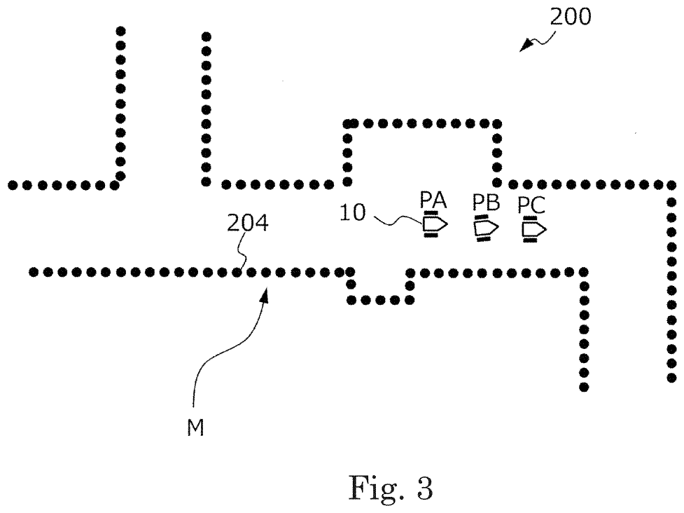

FIG. 3 is a view illustrating a map (map M) of the environment 200 in FIG. 2. Each dot 204 in FIG. 3 corresponds to each point of the point cloud constituting the map M. In the present disclosure, sometimes the point cloud of the map M is referred to as a “reference point cloud”, and the point cloud of scan data is referred to as a “measurement point cloud data” or a “source point cloud”. For example, the matching is alignment of scan data (measurement point cloud data) with respect to the map (reference point cloud) in which the position is fixed. When performing the matching using the ICP algorithm, specifically a pair of corresponding points is selected between the reference point cloud and the measurement point cloud data, and the position and the orientation of the measurement point cloud data are adjusted such that a distance (error) between the points constituting each pair is minimized.

In FIG. 3, for convenience, dots 204 are arranged at equal intervals on a plurality of line segments. The point cloud in the actual map M may have a more complicated arrangement pattern. The map M is not limited to the point cloud map, but may be a map having a straight line or a curve as a constituent element or an occupied grid map. That is, the map M only needs to have a structure capable of performing the matching between the scan data and the map M.

When the mobile body 10 is located at each of a position PA, a position PB, and a position PC in FIG. 3, the scan data acquired by the external sensor 102 of the mobile body 10 has an array of different point clouds. When a moving time of the mobile body 10 from the position PA, through the position PB, to the position PC is sufficiently long as compared with a scan cycle of the external sensor 102, namely, when the mobile body 10 moves slowly, two scan data adjacent on a time axis are very similar to each other. However, when the mobile body 10 moves significantly fast, the two scan data adjacent on the time axis may be largely different from each other.

In this way, among the scan data sequentially output from the external sensor 102, when the latest scan data is similar to the previous scan data, the matching is relatively easy and the high-reliability matching is expected in a short time. However, when the moving speed of the mobile body 10 is relatively high, there is a possibility that the latest scan data is not similar to the previous scan data, and the time necessary for the matching is lengthened, or the matching may not be completed within a predetermined time.

As described later, sometimes the scan data acquired by the mobile body 10 from the surrounding environment lacks information necessary for specification of the position of the mobile body 10 when the mobile body 10 is located in a specific region. In such cases, even if matching is completed, the position of the mobile body 10 cannot be determined as one. In the example embodiment of the present disclosure, the specific region is previously extracted, and the position of the specific region is associated with the map data.

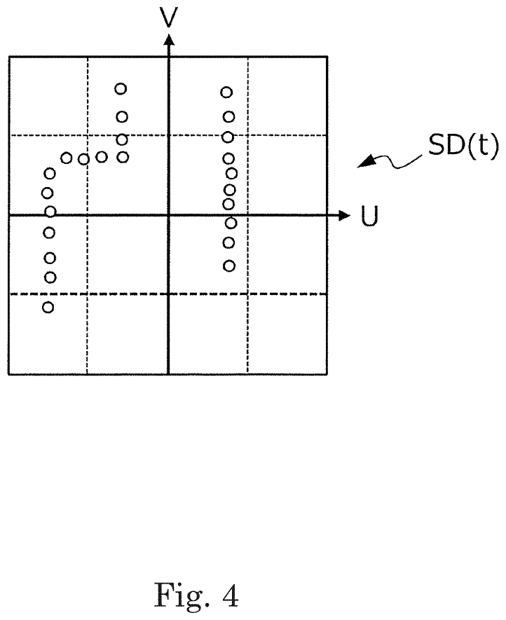

FIG. 4 is a view schematically illustrating an example of scan data SD(t) acquired by the external sensor at time t. The scan data SD(t) is expressed in a sensor coordinate system in which the position and the posture change together with the mobile body 10. The scan data SD(t) is expressed by a UV coordinate system in which a direct front of the external sensor 102 is set to a V-axis while the direction rotated clockwise by 90° from the V-axis is set to a U axis. The mobile body 10, more precisely the external sensor 102, is located at the origin of the UV coordinate system. In the present disclosure, when the mobile body 10 moves forward, the mobile body 10 moves in the direction of the direct front of the external sensor 102, namely, the V-axis. For easy understanding, the point constituting the scan data SD(t) is indicated by a white circle.

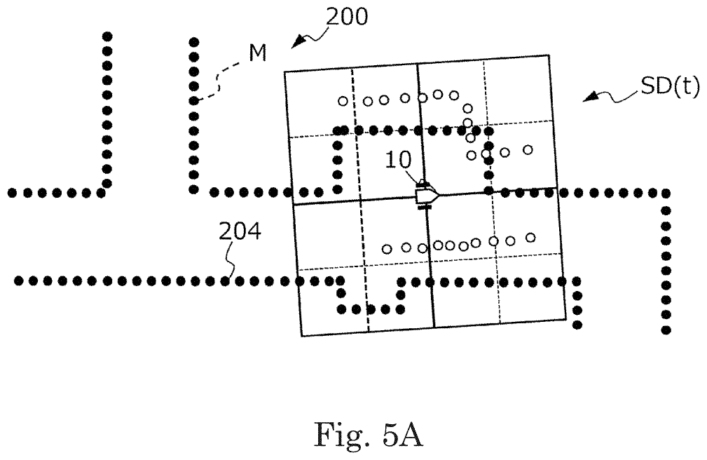

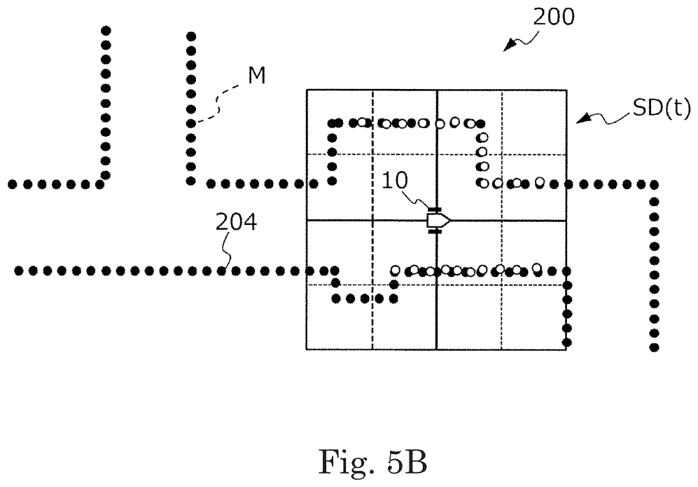

FIG. 5A is a view schematically illustrating a state in which the matching of the scan data SD(t) with the map M is started. The position and the posture of the mobile body 10 in FIG. 5A are given as an initial value at the start of the matching. When the initial position is close to the actual position and posture of the mobile body 10, the time required to reach the matching completion state is sufficiently short.

FIG. 5B is a view schematically illustrating a state in which the matching of the scan data SD(t) with the map M is completed. A relationship between the position and posture of the sensor coordinate system and the position and posture of the coordinate system of the map M when the external sensor acquires the scan data SD(t) is determined in the state in which the matching is completed. In this way, the estimated values of the position (the origin of the sensor coordinate system) and the posture (the orientation of the sensor coordinate system) of the mobile body 10 at the time t are determined (position identification).

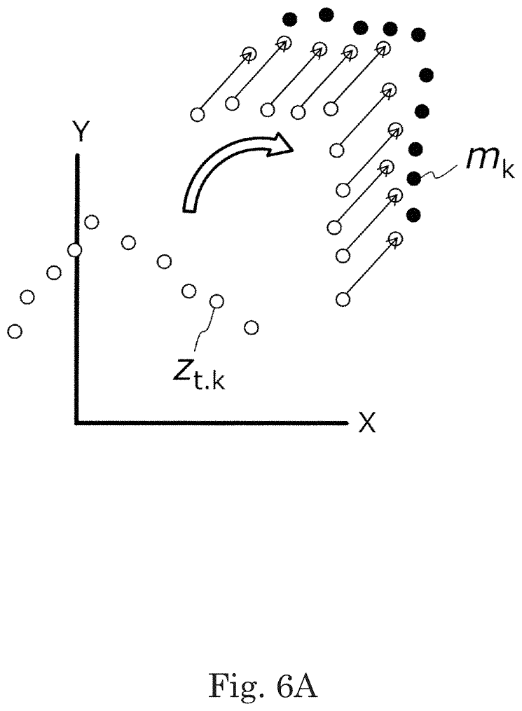

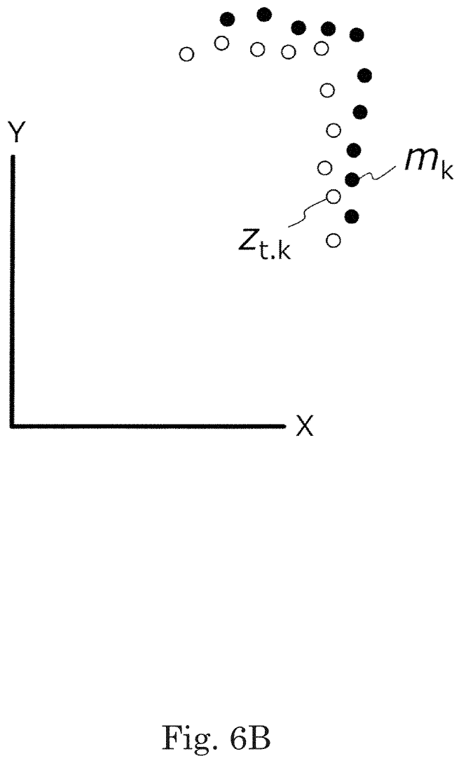

FIG. 6A is a view schematically illustrating a state in which the point cloud constituting the scan data rotates and translates from the initial position and approaches the point cloud on the map. It is assumed that Z_{t,k} is a coordinate value of the k-th (k=1, 2, . . . , K-1, K) point out of the K points constituting the point cloud of the scan data at the time t, and that mₖ is a coordinate value of the corresponding point on the map. At this point, an error of the corresponding points in the two point clouds can be evaluated using Σ(Z_{t,k}−mₖ)² that is a sum of squares of the errors calculated for the K corresponding points as a cost function. Rotational and translational rigid transformations are determined so as to decrease Σ(Z_{t,k}−mₖ)². The rigid transformation is defined by a transformation matrix (homogeneous transformation matrix) including a rotation angle and a translation vector as a parameter.

FIG. 6B is a view illustrating the position and the posture after the rigid transformation of the scan data. In the example of FIG. 6B, the matching between the scan data and the map is not completed, and a large error (positional deviation) still exists between the two point clouds. In order to reduce this displacement, the rigid transformation is further performed. Thus, when the error becomes smaller than a predetermined value, the matching is completed. Coincidence of the matching may be quantitatively expressed based on magnitude of the final error.

As described above, sometimes the environment of the mobile body includes the long passage surrounded by the flat wall surface. When the mobile body moves in the passage, the self-position estimation tends to be uncertain because the scan data is formed by the long linear point cloud.

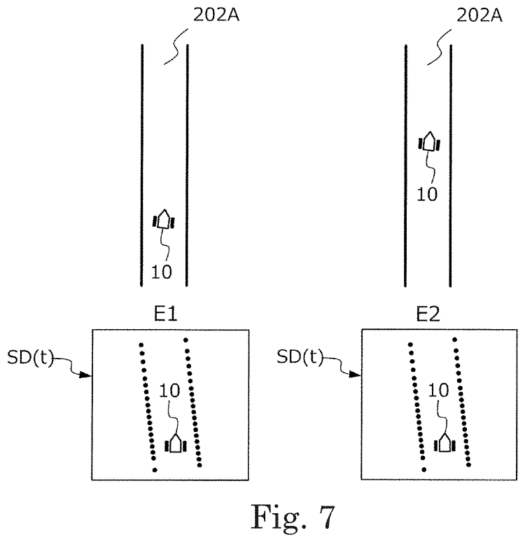

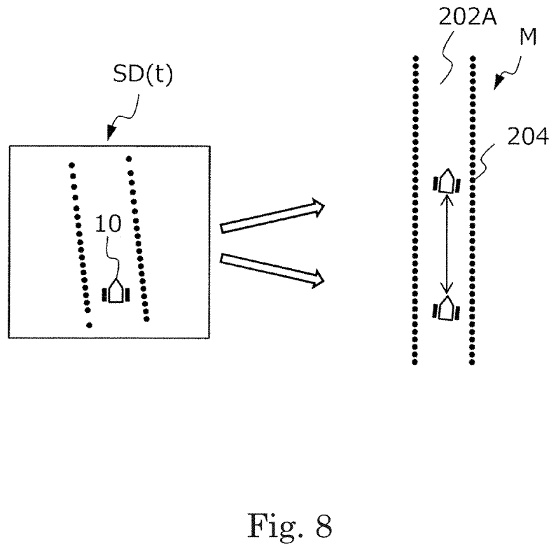

This problem will be described below in more detail with reference to FIGS. 7 and 8.

FIG. 7 schematically illustrates the mobile body 10 located at different positions in a passage 202A extending linearly long in one direction and the scan data SD(t) acquired at each position. The mobile body 10 in a state E1 illustrated on the left side of FIG. 7 and the mobile body 10 in a state E2 illustrated on the right side of FIG. 7 are located at different positions along the passage 202A. However, the scan data SD(t) does not have the substantial difference between the state E1 and the state E2. For this reason, when the matching is performed between the scan data SD(t) and the data of the map M, the position of the mobile body 10 is not fixed to one.

In FIG. 8, a position range of the mobile body 10 that may erroneously be estimated based on the scan data SD(t) acquired by the mobile body 10 moving in the passage 202A is indicated by an arrow. The position range of the mobile body 10 has an expanse, and the position of the mobile body 10 is not fixed to one.

The reason why the position of the mobile body 10 is not uniquely fixed in this way is that a portion in which the matching is performed between the scan data SD(t) and the data of the map M is mainly configured by the linearly arrayed point cloud. For this reason, an error may be generated in the position estimation along the direction in which the passage 202A extends.

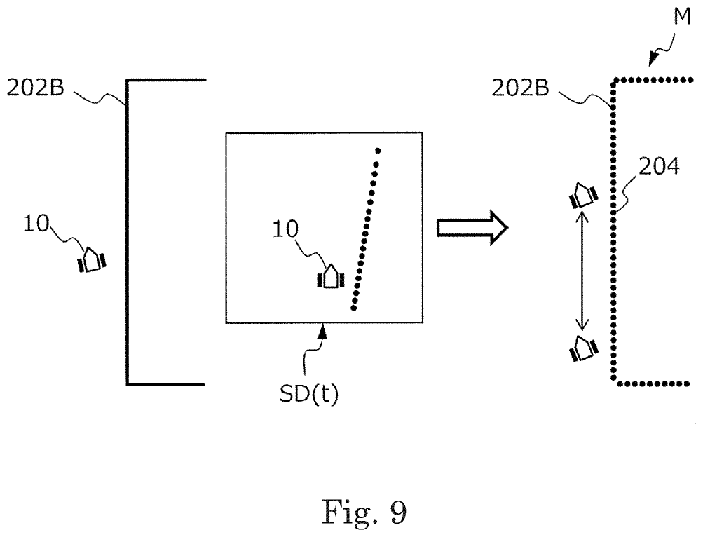

FIG. 9 schematically illustrates the scan data SD(t) acquired when the mobile body 10 is moving in a place where a flat wall surface 202B exists on one side of the route while an object (reflector) such as a wall does not exist on the other side. Even if the matching is performed between the scan data SD(t) and the data of the map M, the same problem as the above problem can be generated. On the right side of FIG. 9, the position range of the mobile body 10 that may be erroneously estimated is indicated by an arrow. In this case, the reason why the position of the mobile body 10 is not fixed to one is that the position in the direction parallel to the straight line cannot be determined because the portion in which the matching is performed between the scan data SD(t) and the data of the map M is mainly constituted by the linearly arrayed point cloud.

When the mobile body 10 is located in a specific region defined by a relatively long line segment in the two-dimensional map of the environment, the matching errors can converge to the same size in a wide range along the line segment in the scan data SD(t) that can be acquired from the surrounding environment by the mobile body 10, namely, the measurement point cloud data. In such cases, large uncertainty is generated in the self-position estimation, and the reliability of the position estimation is degraded.

In the example embodiment of the present disclosure, the specific region can be selected from the map data, and recorded in association with the map data. The recording of additional information relating to the specific region in association with the map data created by a conventional method is referred to as “processing the map data” in the present disclosure. The processing of the map data includes both a case where a content of the map data itself is changed and a case where the data of the specific region is created without changing the content of the map data.

An example of a device (map data processing device) and a method (map data processing method) for processing the map data in the example embodiment will be described below.

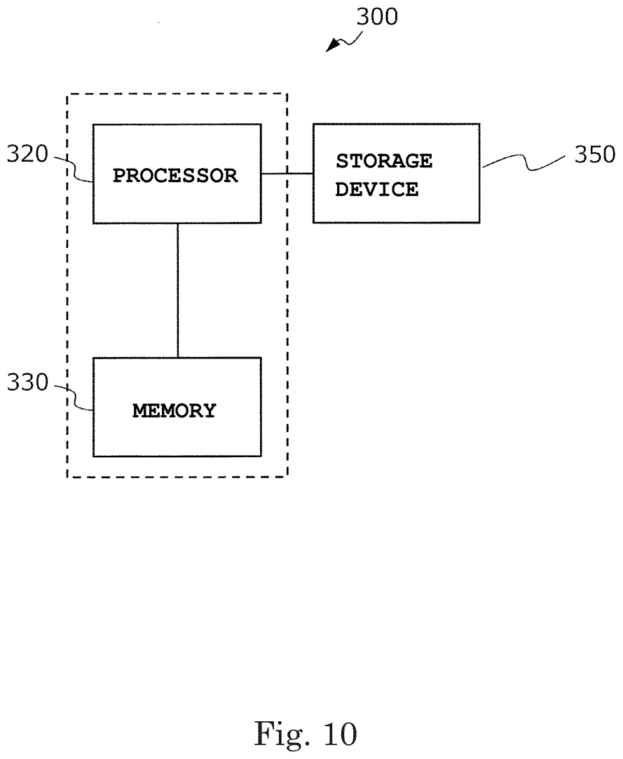

FIG. 10 illustrates a configuration example of a device 300 that processes the map data in the example embodiment of the present disclosure. The illustrated device 300 includes a processor 320 and a memory 330 that stores a computer program operating the processor 320. A typical example of the device 300 is a personal computer (PC) in which the computer program creating and processing the map is installed. For example, the processor 320 may be a commercially available microcontroller or signal processor. The memory 330 stores the computer program necessary for the operation of the processor 320. The method of the present disclosure is performed while implemented on the computer.

The processor 320 can access a storage device 350 in which the data of the two-dimensional map having the point cloud or a plurality of occupied grids is stored. The storage device 350 in FIG. 10 may be the same device as the storage device 350 in FIG. 1.

The processor 320 performs the following processing according to a command of the computer program stored in the memory 330.

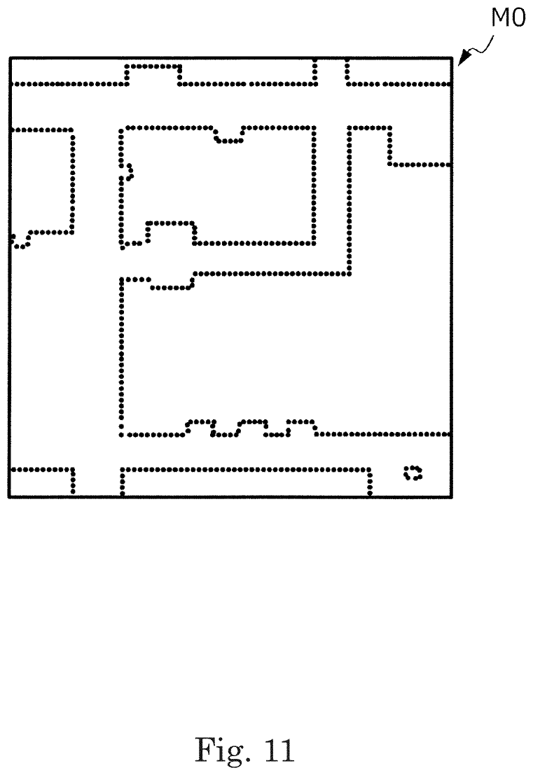

(1) The data of the two-dimensional map is read from the storage device 350. The map data may be data created by another map creation device, or data created by the device 300 in FIG. 10. For example, the map data can be created using an SLAM technique. FIG. 11 illustrates a two-dimensional map M0 having the point cloud as an example. The two-dimensional map M0 may be an occupied grid map.

(2) One or a plurality of line segments defined by the point cloud or a plurality of occupied grids on the two-dimensional map M0 are extracted from the two-dimensional map. A specific example of the method for extracting the line segment will be described later.

(3) At least one specific region is selected from at least one region included in one or a plurality of line segments or at least one region defined by at least one pair of line segments, and the additional data indicating the position of the specific region on the two-dimensional map M0 is stored in the storage device 350 in association with the data of the two-dimensional map M0. For example, the region defined by at least one line segment is a region defined by the wall surface 202B in FIG. 9. For example, the region defined by at least one pair of line segments is the passage 202A in FIG. 7.

In the example embodiment, when extracting the plurality of line segments from the two-dimensional map M0, the processor 320 sequentially extracts the plurality of line segments having different lengths. More specifically, the line segments having different lengths are sequentially extracted from a first length Lₘₐₓ to a second length Lₘᵢₙ that are less than or equal to a maximum diagonal length of the two-dimensional map M0 (Lₘₐₓ>Lₘᵢₙ). A value larger than the length on the map corresponding to the length of the mobile body 10 (for example, 1 meter) is given to the second length Lₘᵢₙ. This is because usually the existence of the line segment shorter than the length of the mobile body 10 included in the map data does not adversely affect the position estimation. The point cloud on the map in which the relatively long line segment is extracted is excluded from a matching target of the virtual line segment shorter than the line segment. As a result, wasteful extraction of the same line segment can be eliminated.

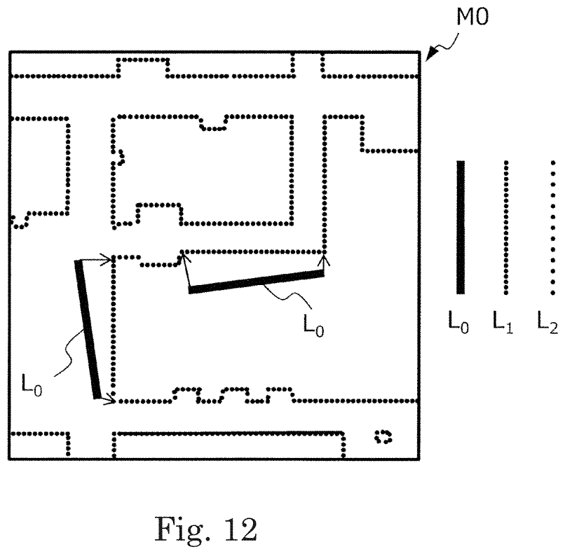

FIG. 12 schematically illustrates a state in which a virtual line segment Lo having a certain length is extracted. The processor 320 generates the virtual line segment Lo and performs the matching between the point cloud included in the two-dimensional map M0 and each virtual line segment. When the matching is not achieved in the virtual line segment Lo having the length, another virtual line segment having a shorter length is generated, and the matching is performed between the point cloud included in the two-dimensional map M0 and each virtual line segment L₀. For example, these matchings can be performed by ICP matching. When the current virtual line segment is configured by Q points, the length of the next virtual line segment can be set to (Q−N) points, for example. For example, N is an integer of 1 or more and 10 or less.

As illustrated on the right side of the two-dimensional map M0 in FIG. 12, the example of the virtual line segment L₀ includes not only the solid line segment L₀, but also virtual line segments L₁, L₂ defined by the linear point cloud configured by a plurality of points arrayed on the straight line at predetermined intervals. The number and density of points included in one of the virtual line segments L₁, L₂ and the interval between adjacent points can be determined from the viewpoint of efficiently performing the matching calculation. When the two-dimensional map M0 is a point cloud map, a virtual line segment may be formed from the point cloud having the interval matched with the interval between the points on the two-dimensional map M0. Alternatively, the virtual line segment may be formed from the point cloud having the interval wider than the interval between the points on the two-dimensional map M0. For example, when the interval between points on the two-dimensional map M0 is set to the interval equivalent to the length of 0.1 meters in the real space of the environment, each virtual line segment may be formed by the plurality of points arranged on the straight line at corresponding intervals equivalent to the length of 0.2 meters in the real space of the environment.

The range to be the matching target in the two-dimensional map M0 is typically the whole range of the two-dimensional map M0, but a specific range may previously be excluded. The line segment can be extracted from the whole range of the two-dimensional map M0 without omission by widely changing the initial position of the virtual line segment in the range of the matching target. In order to perform the efficient matching, the initial position of the virtual line segment may be selected from the region where the density of the point cloud is high in the map data. For example, the initial position of the virtual line segment can be specified by “the positions at both ends of the virtual line segment” or “the center position of the virtual line segment and the orientation of the virtual line segment”.

The method for extracting the line segment may be performed by image processing with no use of the matching between the virtual line segments and the map data. For example, the straight line passing through the point cloud may be extracted by Hough transform.

The processor 320 acquires information defining the position, the length, and the orientation for the extracted one or the plurality of line segments, and stores the information in the storage device 350. Examples of the information defining “the position, the length, and the orientation” of the line segment include “the coordinate value of a midpoint of the line segment, the length of the line segment, and an angle to a reference axis”, and “the coordinate value at one end of the line segment and the coordinate value at the other end”.

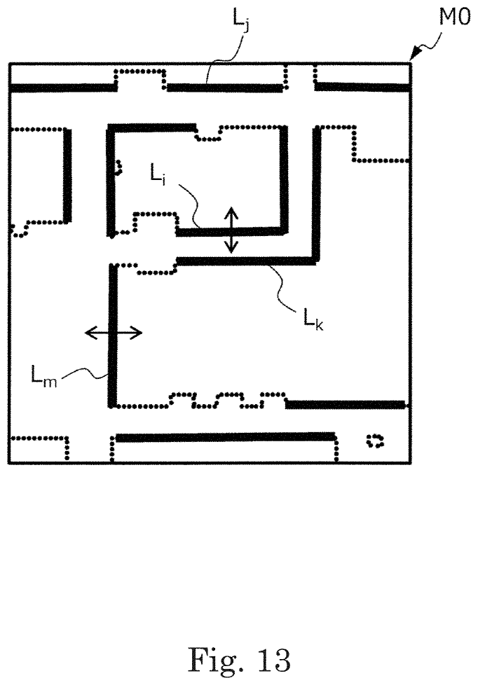

FIG. 13 illustrates the map to which the extracted line segment is added. In FIG. 13, the extracted line segment is indicated by a relatively thick solid line. An example of a method for selecting the specific region from these line segments will be described below. The case where the plurality of line segments are extracted will be described below as an example.

When selecting the specific region from the two-dimensional map having the point cloud, the processor 320 performs the following processing in the example embodiment.

A first line segment (reference line segment) is selected from the plurality of extracted line segments. The selection of the first line segment is arbitrary. The “first line segment” may sequentially be extracted from the longest line segment among the plurality of extracted line segments. In the example of FIG. 13, for example, a line segment Lᵢ is selected as the “first line segment”. Subsequently, a second line segment orthogonal to the straight line extending in a normal direction from the midpoint of the first line segment (Lᵢ) is searched. In the example of FIG. 13, a line segment Lⱼ and a line segment Lₖ are found as the second line segment. In the example of FIG. 13, the point cloud exists between the line segment Lⱼ and the line segment Lᵢ, but the point cloud does not exist between the line segment Lₖ and the line segment Lᵢ. As described above, when the point cloud does not exist between the second line segment Lₖ and the first line segment Lᵢ, the second line segment Lₖ and the first line segment Lᵢ are selected as a pair. The region sandwiched between the first line segment Lᵢ and the second line segment Lₖ constituting the pair is determined as the specific region (the region corresponding to a both-side straight passage).

When the first line segment Lᵢ and the second line segment Lk constituting the pair are found by the above method, the region sandwiched between line segment Lᵢ and the line segment Lₖ may be excluded from the specific region based on the difference in length between the line segments Lᵢ, Lₖ. When the difference in length between the line segments Lᵢ, Lₖ is larger than a predetermined value, the region sandwiched between the line segment Lᵢ and the line segment Lₖ may be excluded from the specific region because the region is improper as the both-side passage. When the interval between the first line segment Lᵢ and the second line segment Lₖ is smaller than a predetermined value (for example, the width of the mobile body 10), the region sandwiched between the line segment Lᵢ and the line segment Lₖ may be excluded from the specific region.

After the processing of selecting the specific region using the first line segment Lᵢ is completed, another line segment is selected as the first line segment to repeat the processing of selecting the specific region. In the example of FIG. 13, for example, the line segment Lₘ is selected as the next “first line segment”, and when the point cloud does not exist in the normal direction from the midpoint of the first line segment (Lm), the region extending in the normal direction from the first line segment Lₘ is selected as the specific region (the region corresponding to a one-side straight region). In the example of FIG. 13, the point cloud exists in the normal direction on the right side from the midpoint of the line segment Lₘ, whereas the point cloud does not exist in the normal direction on the left side from the midpoint of the line segment Lₘ.

The specific region determined in this way includes the both-side straight passage longer than the second length Lₘᵢₙ or the one-side straight region longer than the second length Lₘᵢₙ. The position of the specific region can be designated by the coordinate values at both ends of each of the two line segments Lᵢ, Lₖ defining the both-side straight passage or the coordinate values at both ends of one line segment Lₘ defining the one-side straight region.

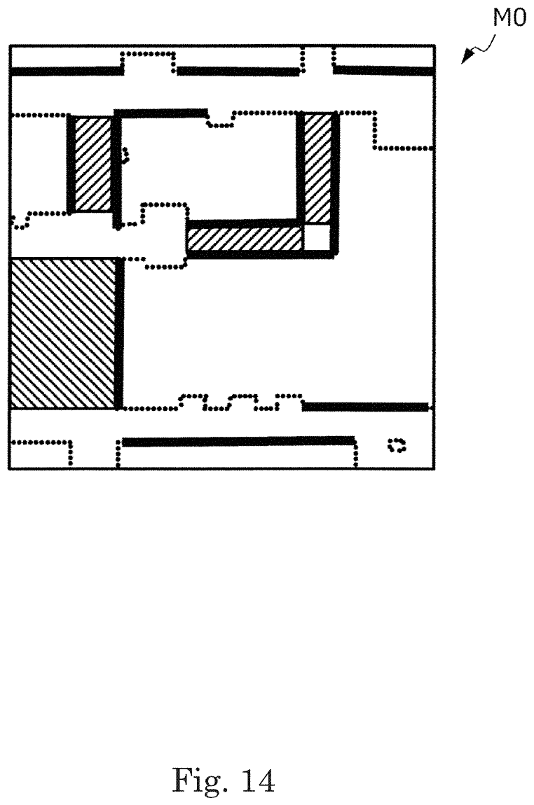

FIG. 14 schematically illustrates the map data to which the specific region (hatched region) is added. For example, the position of the specific region can be designated by the coordinate values at both the ends of each of the two line segments defining the both-side straight passage or the coordinate values at both the ends of one line segment defining the one-side straight region. For this reason, when the data indicating the position of the specific region is associated with the data of the two-dimensional map, it is not necessary to synthesize them as one data.

When selecting the specific region from the two-dimensional map having the occupied grid, the processor 320 may perform the following processing. That is, among the plurality of extracted line segments, the first line segment and the second line segment that is orthogonal to the straight line extending in the normal direction from the midpoint of the first line segment to form a free space (the region where an obstacle to the mobile body does not exist) between the first line segment and the second line segment is selected as a pair. The region sandwiched between the first line segment and the second line segment constituting the pair is determined as the specific region (the region corresponding to the both-side straight passage). When only the free space exists in the normal direction from the midpoint of the first line segment, the region extending in the normal direction from the first line segment is determined as the specific region (the region corresponding to the one-side straight region).

When the one line segment is extracted from the point cloud map or the occupied grid map, whether the extracted line segment is the line segment defining the one-side straight region is determined in the same manner as the above.

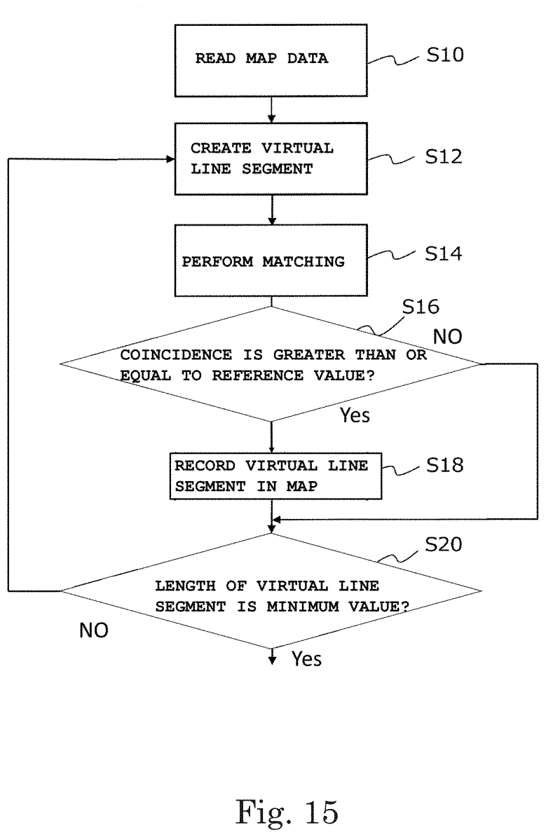

The above processing flow performed by the device 300 in FIG. 10 will be described below with reference to FIGS. 15 to 17.

In step S10 of FIG. 15, the processor 320 reads the map data from the storage device 350.

In step S12, the processor 320 creates the virtual line segment having a predetermined length. The initial length is set to the “first length Lₘₐₓ”.

In step S14, the processor 320 performs the matching between the map data and the virtual line segment.

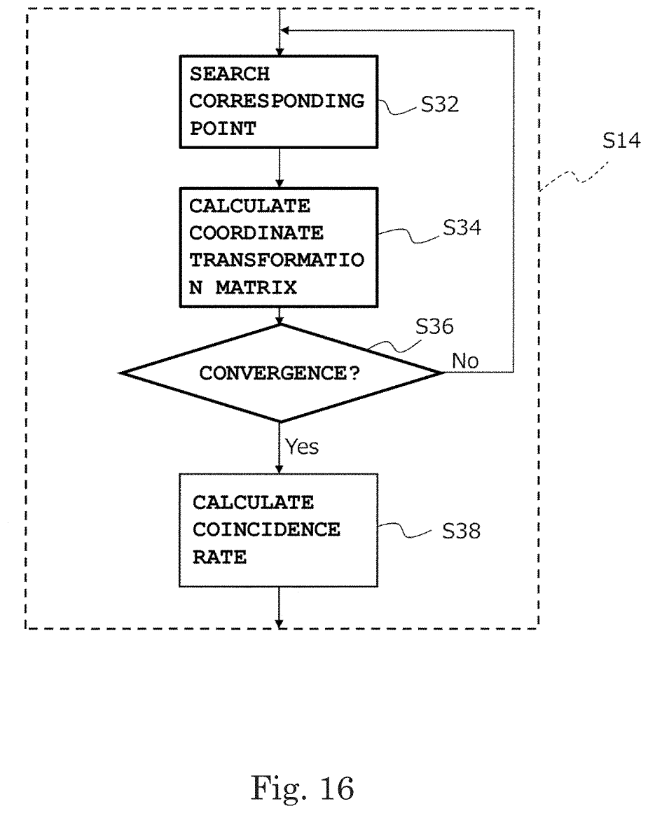

At this point, a matching flow will be described with reference to FIG. 16.

In step S32, the processor 320 searches the corresponding point. Specifically, the processor 320 selects the point on the map corresponding to each point constituting the point cloud included in the virtual line segment.

In step S34, the processor 320 performs the rotation and translation rigid body transformations (coordinate transformations) of the virtual line segment so as to shorten the distance between the corresponding points located between the virtual line segment and the map. This means optimization of the parameters of the coordinate transformation matrix so as to decrease the distance between corresponding points, namely, the total sum (square sum) of the errors of the corresponding points. The optimization is performed by iterative calculation.

In step S36, the processor 320 determines whether the result of the iterative calculation converges. Specifically, the determination that the convergence is achieved is made when the total sum (square sum) of the errors of the corresponding points falls below a predetermined value even if the parameters of the coordinate transformation matrix are changed. When the convergence is not achieved, the processing returns to step S32, and the pieces of processing from the processing of searching the corresponding point are repeated. When the determination that the convergence is achieved is made in step S36, the processing proceeds to step S38.

In step S38, the processor 320 calculates a coincidence rate. Subsequently, the processing proceeds to step S16 in FIG. 15.

FIG. 15 is referred to again. When the coincidence rate is greater than or equal to a reference value in step S16, the processing proceeds to step S18. In step S18, the processor 320 records the virtual line segment in the map. Specifically, the processor 320 stores the data including the position information about the virtual line segment in the storage device 350. The data including the position information about the virtual line segment and the map data constitute the map data to which the virtual line segment is added as a whole.

In step S20, the processor 320 determines whether the length of the virtual line segment is the minimum value (second length Lₘᵢₙ). The processor 320 ends the processing when the length is the minimum value, and the processing returns to step S12 when the length is not the minimum value. When the coincidence rate is less than the reference value in step S16, the determination is made that the line segment having the length cannot be extracted, and the processing proceeds to step S20 to create the next virtual line segment. In this way, the virtual line segments having different lengths are sequentially created and used for the matching with the map.

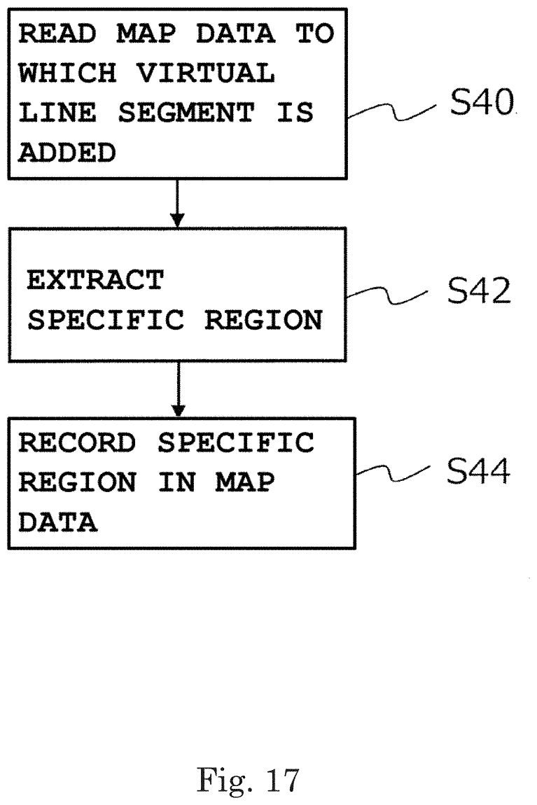

A specific region extraction flow will be described below with reference to FIG. 17.

In step S40, the processor 320 reads the map data to which the virtual line segment is added from the storage device 350.

In step S42, the processor 320 extracts (selects) the specific region from the map data to which the virtual line segment is added by the above various methods.

In step S44, the processor 320 records the specific region in the map data. As used herein, “recording the specific region in the map data” means that both the data indicating the position of the specific region (load data) and the map data are stored in the storage device such as the storage device 350.

Processing of the map data is performed by the above operation flow. The map data processed in this way can be recorded as the map in the storage device 104 of the mobile body 10 in FIG. 1. When the mobile body 10 moves while estimating the self-position, the map recorded in the storage device 104 is used for the operation of the self-position estimation device.

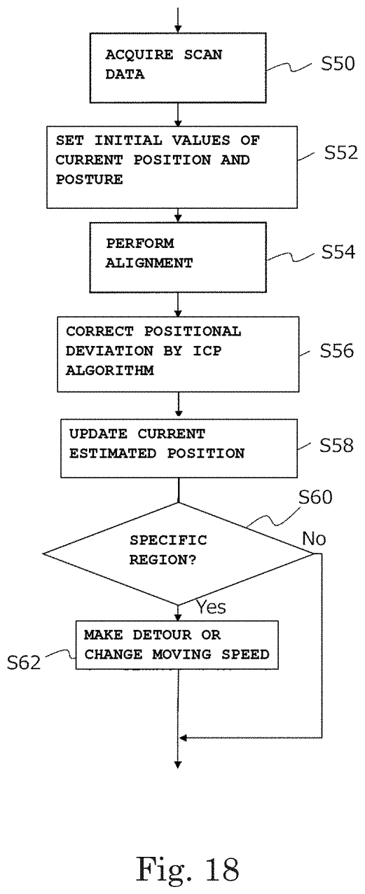

An example of an operation flow performed by the mobile body 10 using the processed map data will be described below with reference to FIG. 18.

In step S50, the position estimation device 106 (see FIG. 1) of the mobile body 10 acquires the scan data of the surrounding environment from the external sensor 102.

In step S52, the position estimation device 106 sets initial values of the current position and posture.

In step S54, the position estimation device 106 performs the alignment using the initial values.

In step S56, the position estimation device 106 performs positional deviation correction by the ICP algorithm. This operation is basically the same as the operation described with reference to FIG. 16.

In step S58, the position estimation device 106 updates the current estimated position of the mobile body 10 from the initial position.

In step S60, whether the current estimated position of the mobile body 10 is in the specific region or is near the specific region is determined. When the current estimated position of the mobile body 10 is in the specific region or is near the specific region, the processing proceeds to step S62. When the current estimated position of the mobile body 10 is neither in the specific region nor is near the specific region, the mobile body 10 continues the normal operation.

In step S62, for example, the automatic traveling control device 110 (see FIG. 1) of the mobile body 10 can perform at least one of the following pieces of processing.

(i) The mobile body 10 makes a detour around the specific region.

(ii) The moving speed of the mobile body 10 is decreased before the mobile body 10 enters the specific region.

(iii) The moving speed of the mobile body 10 is decreased or increased after the mobile body 10 enters the specific region.

(iv) A warning signal is output before or after the mobile body enters the specific region.

Through these pieces of processing, various operations can be performed in consideration of the specific region. At this point, the decrease in moving speed includes stop of the mobile body 10. When the moving speed of the mobile body 10 is increased, the time necessary for the mobile body 10 to move in the specific region can be shortened, so that the time for which the uncertainty of the self-position estimation becomes relatively high can be shortened.

The mobile body of the example embodiment of the present disclosure will be described in more detail below. In the example embodiment, the automatic guided vehicle is taken as an example of the mobile body. In the following description, the automatic guided vehicle is abbreviated and described as “AGV”. Hereinafter, the “AGV” is also designated by the reference numeral “10” in the same manner as the mobile body 10.

### (1) Basic Configuration of System

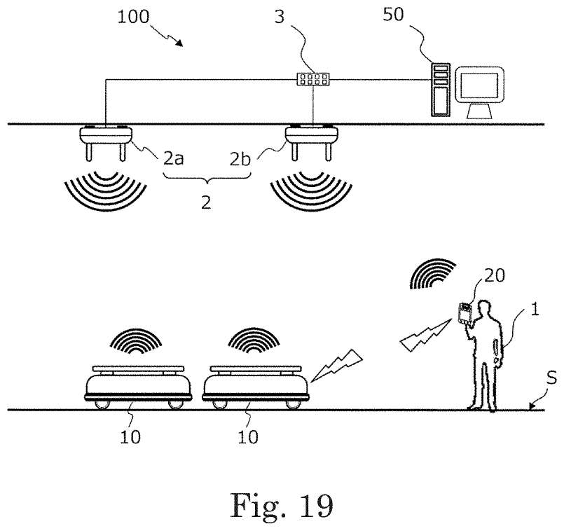

FIG. 19 illustrates a basic configuration example of an exemplary mobile management system 100 of the present disclosure. The mobile management system 100 includes at least one AGV 10 and an operation management device 50 that manages the operation of the AGV 10. FIG. 19 also illustrates a terminal device 20 operated by a user 1.

The AGV 10 is an automatic guided transport truck that can perform “guideless type” traveling in which the inductor such as a magnetic tape is not necessary for traveling. The AGV 10 can perform the self-position estimation, and transmit the estimation result to the terminal device 20 and the operation management device 50. The AGV 10 can automatically travel in the environment S according to a command from the operation management device 50.

The operation management device 50 is a computer system that tracks the position of each AGV 10 and manages the traveling of each AGV 10. The operation management device 50 may be a desktop PC, a notebook PC, and/or a server computer. The operation management device 50 communicates with each AGV 10 through a plurality of access points 2. For example, the operation management device 50 transmits, to each AGV 10, the data of the coordinates of the position to which each AGV 10 should go next. Each AGV 10 periodically transmits the data indicating its position and posture (orientation) to the operation management device 50, for example, every 250 milliseconds. When the AGV 10 reaches the instructed position, the operation management device 50 further transmits the coordinate data of the position to which each AGV 10 should go next. The AGV 10 can also travel in an environment S according to the operation of the user 1 input to the terminal device 20. An example of the terminal device 20 is a tablet computer.

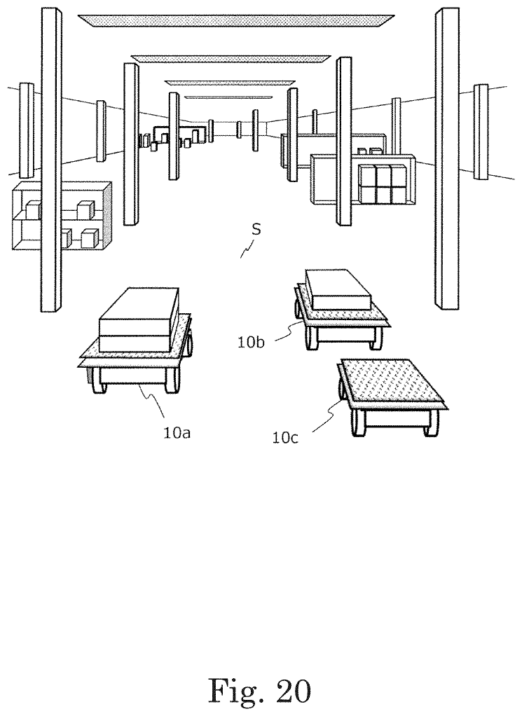

FIG. 20 shows an example of the environment S in which three AGVs 10a, 10b, and 10c exist. It is assumed that all the AGVs are traveling in the depth direction of FIG. 20. The AGVs 10a and 10b are currently transporting the cargos placed on a top board. The AGV 10c is traveling while following the forward AGV 10b. For convenience, the reference numerals 10a, 10b, and 10c are attached in FIG. 20, but hereinafter, the AGVs 10a, 10b, and 10c are referred to as “AGV 10”.

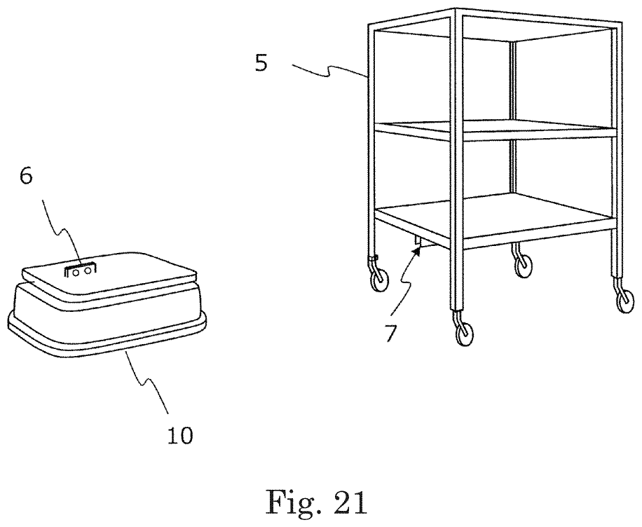

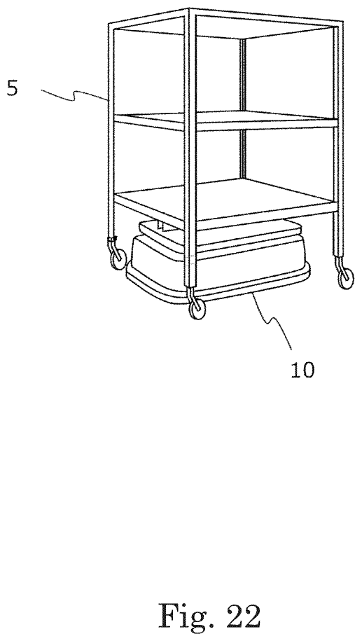

In addition to the method for transporting the cargos placed on the top board, the AGV 10 can also transport the cargos using a towing truck connected to the AGV 10. FIG. 21 illustrates the AGV 10 and the towing truck 5 before the connection. A caster is provided on each foot of the towing truck 5. The AGV 10 is mechanically connected to the towing truck 5. FIG. 22 illustrates the AGV 10 and the towing truck 5 connected to each other. When the AGV 10 travels, the towing truck 5 is towed by the AGV 10. By towing the towing truck 5, the AGV 10 can carry the cargo placed on the towing truck 5.

The method for connecting the AGV 10 and the towing truck 5 is arbitrary. At this point, an example will be described. A plate 6 is fixed to the top board of the AGV 10. A guide 7 including a slit is provided in the towing truck 5. The AGV 10 approaches the towing truck 5 to insert the plate 6 into the slit of the guide 7. When the insertion is completed, the AGV 10 passes an electromagnetic lock pin (not illustrated) through the plate 6 and the guide 7 and sets an electromagnetic lock. Consequently, the AGV 10 and the towing truck 5 are physically connected to each other.

FIG. 19 is referred to again. Each AGV 10 and the terminal device 20 can be connected on a one-to-one basis to conduct the communication conforming to the Bluetooth (registered trademark) standard. Each AGV 10 and the terminal device 20 can conduct the communication conforming to Wi-Fi (registered trademark) using one or a plurality of access points 2. For example, the plurality of access points 2 are connected to each other through a switching hub 3. FIG. 19 illustrates two access points 2a, 2b. The AGV 10 is wirelessly connected to the access point 2a. The terminal device 20 is wirelessly connected to the access point 2b. The data transmitted from the AGV 10 is received by the access point 2a, transferred to the access point 2b through the switching hub 3, and transmitted from the access point 2b to the terminal device 20. The data transmitted from the terminal device 20 is received by the access point 2b, transferred to the access point 2a through the switching hub 3, and transmitted from the access point 2a to the AGV 10. Consequently, bidirectional communication is performed between the AGV 10 and the terminal device 20. The plurality of access points 2 are also connected to the operation management device 50 through the switching hub 3. Consequently, the bidirectional communication is performed between the operation management device 50 and each AGV 10.

### (2) Creation of Map

The map in the environment S is created such that the AGV 10 can travel while estimating the self-position. The AGV 10 is equipped with the position estimation device and the LRF, and can create the map using output of the LRF.

The AGV 10 transitions to a data acquisition mode by a user operation. In the data acquisition mode, the AGV 10 starts the acquisition of the sensor data using the LRF.

The position estimation device accumulates the sensor data in the storage device. When the acquisition of the sensor data in the environment S is completed, the sensor data stored in the storage device is transmitted to the external device. For example, the external device is a computer including a signal processor, and a map creation computer program is installed on the computer.

The signal processor of the external device superimposes the sensor data obtained for each scan. The map of the environment S can be created by repeatedly performing the superimposition processing by the signal processor. The map is processed using the device 300 (see FIG. 10) that processes the map. The device 300 creates the data indicating the position of the specific region selected from the map. The external device transmits the processed map data to the AGV 10. The AGV 10 stores the processed map data in the internal storage device. The external device may be the operation management device 50 or another device.

The AGV 10 may create and process the map instead of the external device. The processing performed by the signal processor of the external device may be performed by a circuit such as a microcontroller unit (microcomputer) of the AGV 10. When the map is created in AGV 10, it is not necessary to transmit the accumulated sensor data to the external device. A data capacity of the sensor data is generally considered to be large. Because the transmission of the sensor data to the external device is not required, occupation of the communication line can be avoided.

The movement in the environment S for the purpose of the acquisition of the sensor data can be performed by the traveling of the AGV 10 according to the user's operation. For example, the AGV 10 receives a traveling command instructing the movement in the front, rear, left, and right directions from the user through the terminal device 20 in the wireless manner. The AGV 10 travels in the environment S in the front-rear and left-right directions according to the traveling command, and creates the map. When being connected to a steering device such as a joystick in the wired manner, the AGV 10 may travel in the environment S in the front, rear, left, and right directions according to a control signal from the steering device to create the map. The sensor data may be acquired such that a person walks while pushing a measurement truck equipped with the LRF.

FIGS. 19 and 20 illustrate the plurality of AGVs 10. Alternatively, one AGV may be used. When the plurality of AGVs 10 exist, the user 1 can use the terminal device 20 to select one AGV 10 from the plurality of registered AGVs, and create the map of the environment S.

After the map is created, each AGV 10 can travel automatically while estimating the self-position using the map.

### (3) Configuration of AGV

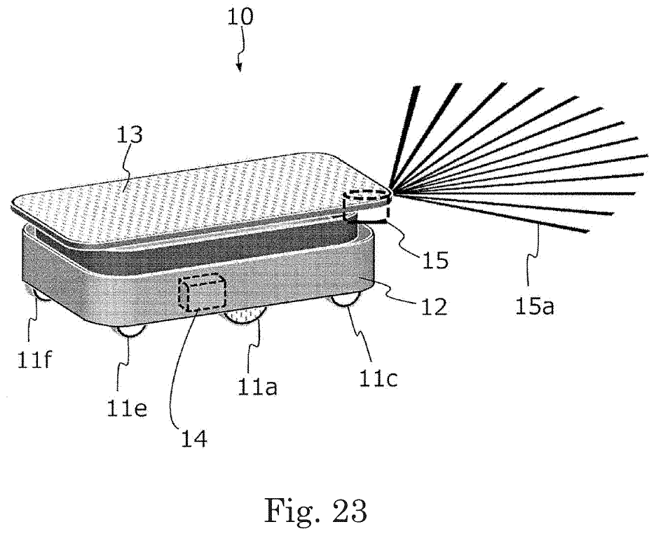

FIG. 23 is an external view illustrating the exemplary AGV 10 of the present example embodiment. The AGV 10 includes two drive wheels 11a and 11, four casters 11c, 11d, 11e and 11f, a frame 12, a transportation table 13, a traveling control device 14, and an LRF 15. The two drive wheels 11a and 11b are provided on the right side and the left side of the AGV 10, respectively.

The four casters 11c, 11d, 11e and 11f are disposed at four corners of the AGV 10. The AGV 10 also includes a plurality of motors connected to the two drive wheels 11a and 11b, but the plurality of motors are not illustrated in FIG. 23. FIG. 23 illustrates one drive wheel 11a and two casters 11c and 11e located on the right side of the AGV 10 and a caster 11f located on the left rear part, but the left-side drive wheel 11b and the caster 11d of the left front are not illustrated because drive wheel 11b and the caster 11d are hidden behind the frame 12. The four casters 11c, 11d, 11e and 11f can turn freely. In the following description, the drive wheels 11a and the drive wheels 11b are also referred to as a wheel 11a and a wheel 11b, respectively.

The traveling control device 14 is a device that controls the operation of the AGV 10, and mainly includes an integrated circuit including a microcomputer (described later), an electronic component, and a board on which the microcomputer and the electronic component are mounted. The traveling control device 14 performs the transmission and reception of the data to and from the terminal device 20 and preprocessing calculation.

The LRF 15 is an optical device that measures the distance to the reflection point by emitting an infrared laser beam 15a and detecting the reflected light of the laser beam 15a. In the example embodiment, for example, the LRF 15 of the AGV 10 emits the pulsed laser beam 15a in the space in the range of 135 degrees to the left and the right (total of 270 degrees) based on the front of the AGV 10 while changing the direction every 0.25 degrees, thereby detecting the reflected light of each laser beam 15a. Consequently, the data of the distance to the reflection point in the direction determined by the angle corresponding to the total of 1081 steps can be obtained for every 0.25 degrees. In the example embodiment, the scan of the surrounding space performed by the LRF 15 is substantially parallel to the floor surface, and is planar (two-dimensional). However, the LRF 15 may perform the scan in a height direction.

The AGV 10 can create the map of the environment S based on the position and the posture (orientation) of the AGV 10 and the scan result of the LRF 15. The map can reflect the wall around the AGV, structures such as a pillar, and the arrangement of objects placed on the floor. The map data is stored in the storage device provided in the AGV 10.

Hereinafter, sometimes the position and the posture of the AGV 10, namely, the pose (x,y,θ) is simply referred to as a “position”.

As described above, the traveling control device 14 compares the measurement result of the LRF 15 to the map data held by the traveling control device 14, and estimates the current self-position. The map data may be map data created by another AGV 10.

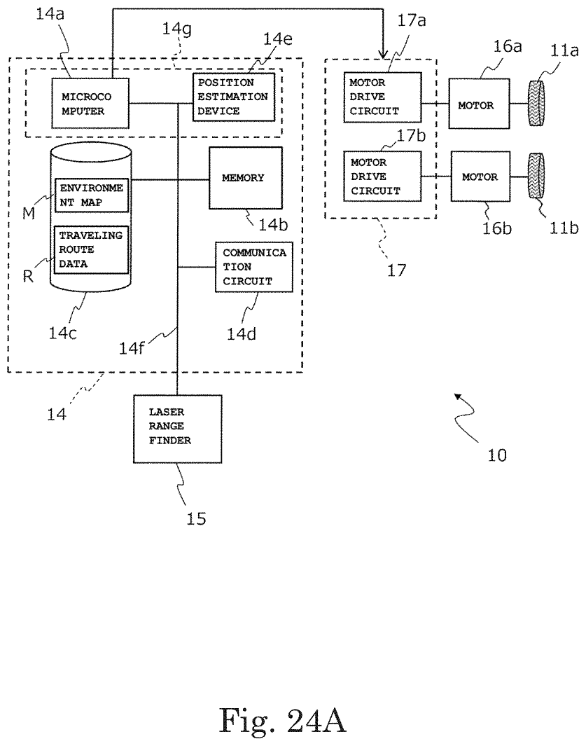

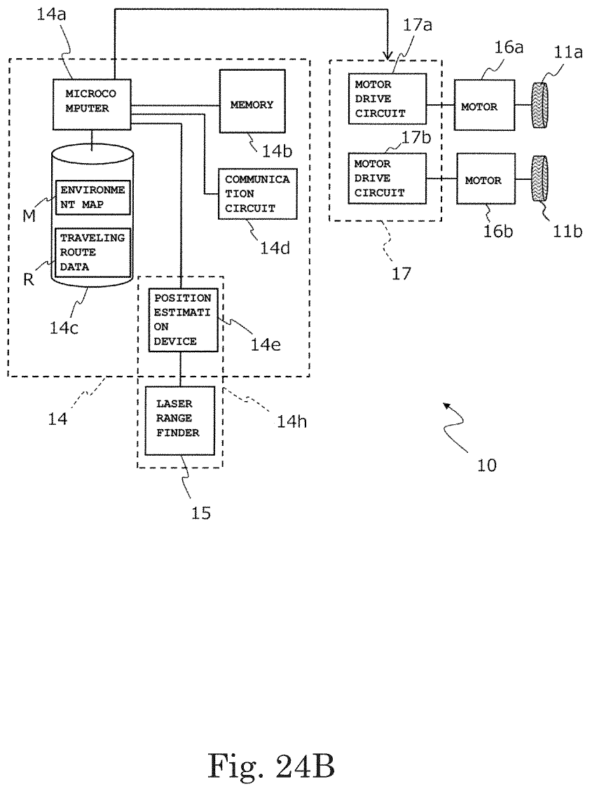

FIG. 24A illustrates an example of a first hardware configuration of the AGV 10. FIG. 24A also illustrates a specific configuration of the traveling control device 14.

The AGV 10 includes the traveling control device 14, the LRF 15, the two motors 16a and 16b, the drive device 17, and the wheels 11a and 11b.

The traveling control device 14 includes a microcomputer 14a, a memory 14b, a storage device 14c, a communication circuit 14d, and a position estimation device 14e. The microcomputer 14a, the memory 14b, the storage device 14c, the communication circuit 14d, and the position estimation device 14e are connected to one another by a communication bus 14f, and can exchange the data with one another. The LRF 15 is also connected to the communication bus 14f through a communication interface (not illustrated), and transmits measurement data that is the measurement result to the microcomputer 14a, the position estimation device 14e, and/or the memory 14b.

The microcomputer 14a is a processor or a control circuit (computer) that performs calculation for controlling the whole AGV including the traveling control device 14. Typically, the microcomputer 14a is a semiconductor integrated circuit. The microcomputer 14a transmits to the drive device 17 a PWM (Pulse Width Modulation) signal that is a control signal to control the drive device 17, thereby adjusting voltage applied to the motor. Consequently, each of the motors 16a and 16b rotates at a desired rotation speed.

At least one control circuit (for example, the microcomputer) that controls the drive of the left and right motors 16a and 16b may be provided independently of the microcomputer 14a. For example, the motor drive device 17 may include two microcomputers that control the drive of the motors 16a and 16b.

The memory 14b is a volatile storage device that stores the computer program executed by the microcomputer 14a. The memory 14b can also be used as a work memory when the microcomputer 14a and the position estimation device 14e perform calculations.

The storage device 14c is a nonvolatile semiconductor memory device. However, the storage device 14c may be a magnetic recording medium typified by a hard disk or an optical recording medium typified by an optical disk. The storage device 14c may include a head device that writes and/or reads the data in and from any recording medium and a control device for the head device.

The storage device 14c stores the map M of the traveling environment S and data (traveling route data) R of one or a plurality of traveling routes. The map M is created by the operation of the AGV 10 in the map creation mode, and stored in the storage device 14c. The traveling route data R is transmitted from the outside after the map M is created. In the example embodiment, the map M and the traveling route data R are stored in the same storage device 14c, but may be stored in different storage devices.

An example of the traveling route data R will be described.

When the terminal device 20 is a tablet computer, the AGV 10 receives the traveling route data R indicating the traveling route from the tablet computer. The traveling route data R at this time includes marker data indicating the positions of a plurality of markers. The “marker” indicates a passing position (via point) of the traveling AGV 10. The traveling route data R includes at least position information about a start marker indicating a traveling start position and an end marker indicating a traveling end position. The traveling route data R may further include position information about the marker of at least one intermediate via point. When the traveling route includes at least one intermediate via point, a route from the start marker to the end marker through the traveling via points in order is defined as the traveling route. The data of each marker can include data of the orientation (angle) and traveling speed of the AGV 10 until movement to the next marker in addition to the coordinate data of the marker. When the AGV 10 temporarily stops at the position of each marker to perform the self-position estimation and notification to the terminal device 20, the data of each marker can include an acceleration time necessary for acceleration to reach the traveling speed and/or a deceleration time necessary for deceleration from the traveling speed until the AGV 10 stops at the position of the next marker.

The operation management device 50 (for example, a PC and/or a server computer) may control the movement of the AGV 10 instead of the terminal device 20. In this case, the operation management device 50 may instruct the AGV 10 to move to the next marker every time the AGV 10 reaches the marker. For example, the AGV 10 receives the coordinate data of a target position that should go next, or the data of the distance to the target position and the angle to be traveled as the traveling route data R indicating the traveling route from the operation management device 50.

The AGV 10 can travel along the stored traveling route while estimating the self-position using the created map and the sensor data output by the LRF 15 acquired during the traveling.

The communication circuit 14d is a wireless communication circuit that conducts wireless communication conforming to, for example, the Bluetooth (registered trademark) and/or Wi-Fi (registered trademark) standards. Each standard includes a wireless communication standard in which a frequency at the 2.4-GHz band is used. For example, in the mode in which the AGV 10 is caused to travel to create the map, the communication circuit 14d conducts wireless communication conforming to the Bluetooth (registered trademark) standard, and communicates with the terminal device 20 on a one-to-one basis.

The position estimation device 14e performs the map creation processing and the self-position estimation processing during the traveling. The position estimation device 14e can create the map of the environment S based on the position and the posture of the AGV 10 and the scan result of the LRF. During the traveling, the position estimation device 14e receives the sensor data from the LRF 15, and reads the map M and the position data of the specific region that are stored in the storage device 14c. The self-position (x, y, θ) on the map M is identified by matching the local map data (sensor data) created from the scan result of the LRF 15 with the wider map M. The position estimation device 14e generates the data of “reliability” indicating a degree of coincidence in which the local map data is matched with the map M. The data of the self-position (x,y,θ) and the data of the reliability can be transmitted from the AGV 10 to the terminal device 20 or the operation management device 50. The terminal device 20 or the operation management device 50 can receive the data of the self-position (x,y,θ) and the data of the reliability, and display the data of the self-position (x,y,θ) and the data of the reliability on a built-in or connected display device.

In the example embodiment, the microcomputer 14a and the position estimation device 14e are individual components, but this is an example. The microcomputer 14a and the position estimation device 14e may be a single chip circuit or a semiconductor integrated circuit capable of independently performing the operation of each of the microcomputer 14a and the position estimation device 14e. FIG. 24A illustrates a chip circuit 14g including the microcomputer 14a and the position estimation device 14e. An example in which the microcomputer 14a and the position estimation device 14e are provided separately and independently will be described below.

The two motors 16a and 16b are attached to the two wheels 11a and 11b, respectively, and rotate the wheels 11a and 11b. That is, the two wheels 11a and 11b are driving wheels. In the example embodiment, the motor 16a and the motor 16b are motors that drive the right wheel and the left wheel of the AGV 10, respectively.

The drive device 17 includes the motor drive circuits 17a and 17b that adjust the voltage applied to the two motors 16a and 16b. Each of motor drive circuits 17a and 17b includes what is called an inverter circuit. The motor drive circuits 17a and 17b turn on or off current passed through each motor by the PWM signal transmitted from the microcomputer 14a or the microcomputer in the motor drive circuit 17a, thereby adjusting the voltage applied to the motor.

FIG. 24B illustrates an example of a second hardware configuration of the AGV 10. The example of the second hardware configuration is different from the example of the first hardware configuration (see FIG. 24A) in that the second hardware configuration includes a laser positioning system 14h and that the microcomputer 14a is connected to each component in a one-to-one manner.

The laser positioning system 14h includes the position estimation device 14e and the LRF 15. The position estimation device 14e and the LRF 15 are connected to each other by, for example, an Ethernet (registered trademark) cable. The operation of each of the position estimation device 14e and the LRF 15 is as described above. The laser positioning system 14h outputs information indicating the pose (x,y,θ) of the AGV 10 to the microcomputer 14a.

The microcomputer 14a includes various general-purpose I/O interfaces or general-purpose input and output ports (not illustrated). The microcomputer 14a is directly connected to other components in the traveling control device 14 such as the communication circuit 14d and the laser positioning system 14h through the general-purpose input and output port.

Other configurations except for the configuration described above with reference to FIG. 24B is the same as the configuration in FIG. 24A. Thus, the description of a common structure will be omitted.

The AGV 10 of the example embodiment of the present disclosure may include safety sensors (not illustrated) such as an obstacle detection sensor and a bumper switch.

### (4) Configuration Example of Operation Management Device

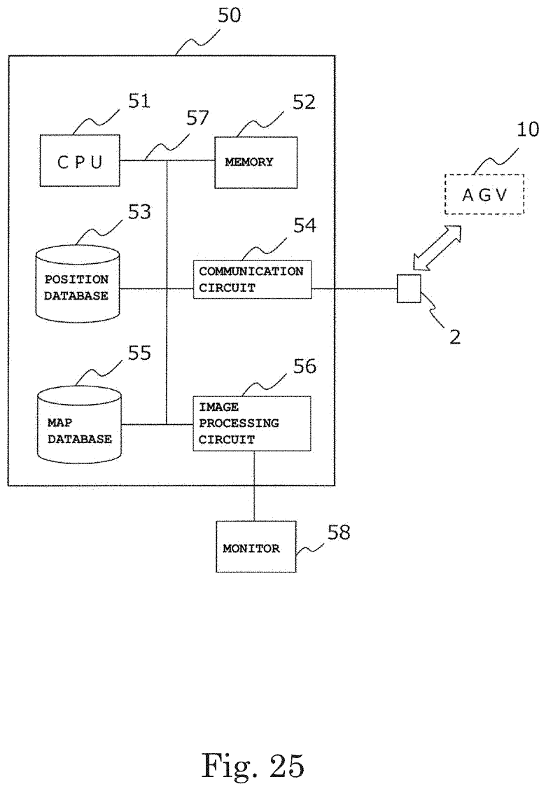

FIG. 25 illustrates an example of a hardware configuration of the operation management device 50. The operation management device 50 includes a CPU 51, a memory 52, a position database (position DB) 53, a communication circuit 54, a map database (map DB) 55, and an image processing circuit 56.

The CPU 51, the memory 52, the position DB 53, the communication circuit 54, the map DB 55, and the image processing circuit 56 are connected to one another by a communication bus 57, and can exchange data with one another.

The CPU 51 is a signal processing circuit (computer) that controls the operation of the operation management device 50. Typically, the CPU 51 is a semiconductor integrated circuit.

The memory 52 is a volatile storage device that stores the computer program executed by the CPU 51. The memory 52 can also be used as a work memory when the CPU 51 performs calculation.

The position DB 53 stores the position data indicating each position that can be a destination of each AGV 10. For example, the position data can be expressed by a virtually-set coordinate in the factory by a manager. The position data is determined by the manager.

For example, the communication circuit 54 conducts wired communication conforming to the Ethernet (registered trademark) standard. The communication circuit 54 is connected to the access point 2 (see FIG. 11) by a wired manner, and can communicate with the AGV 10 through the access point 2. The communication circuit 54 receives the data to be transmitted to the AGV 10 from the CPU 51 through the communication bus 57. The communication circuit 54 transmits the data (notification) received from the AGV 10 to the CPU 51 and/or the memory 52 through the communication bus 57.

The map DB 55 stores the internal map data such as a factory where the AGV 10 travels and the position data of the specific region. A data format is not restricted as long as the map has a one-to-one correspondence with the position of each AGV 10. For example, the map stored in the map DB 55 may be created by CAD.

For example, the operation management device 50 can determine the route of the AGV 10 such that the AGV 10 makes a detour around the specific region.

The position DB 53 and the map DB 55 may be constructed on a nonvolatile semiconductor memory, or constructed on a magnetic recording medium represented by a hard disk or an optical recording medium represented by an optical disk.

The image processing circuit 56 is a circuit that generates video data displayed on the monitor 58. The image processing circuit 56 operates exclusively when a manager operates the operation management device 50. In the example embodiment, further detailed description will be omitted. The monitor 58 may be integrated with the operation management device 50. The CPU 51 may perform the processing of the image processing circuit 56.

The mobile body of the present disclosure can be suitably used to move and transport objects such as cargos, components, and finished products in factories, warehouses, construction sites, logistics, and hospitals.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A device that processes map data used in self-position estimation of a mobile body including an external sensor, the device comprising:
a processor; and
a memory that stores a computer program executable by the processor; wherein according to a command of the computer program, the processor:
reads data of a two-dimensional map from a storage device storing the data of the two-dimensional map including a point cloud or a plurality of occupied grids;
extracts from the two-dimensional map one or a plurality of line segments defined by the point cloud or the plurality of occupied grids on the two-dimensional map;
selects at least one specific region from at least one region included in the one or the plurality of line segments or at least one region defined by at least one pair of line segments; and
associates additional data indicating a position of the at least one specific region on the two-dimensional map with the data.

2. The device according to claim 1, wherein when extracting the one or the plurality of line segments from the two-dimensional map, the processor performs an operation to sequentially extract the plurality of line segments with different lengths from a first length less than or equal to a maximum diagonal length of the two-dimensional map to a second length shorter than the first length.

3. The device according to claim 2, wherein the second length is greater than a total length of the mobile body.

4. The device according to claim 2, wherein the specific region includes a two-sided straight passage longer than the second length or a one-sided straight region longer than the second length.

5. The device according to claim 4, wherein a position of the specific region is designated by coordinate values at two ends of each of the two line segments defining the two-sided straight passage or coordinate values at two ends of the one line segment defining the one-side straight region.

6. The device according to claim 2, wherein when extracting the one or the plurality of line segments from the two-dimensional map, the processor performs matching between each of the plurality of line segments having different lengths and the two-dimensional map.

7. The device according to claim 1, wherein the processor acquires information defining a position, a length, and an orientation of the one or the plurality of extracted line segments, and stores the information in the storage device.

8. The device according to claim 1, wherein when selecting the at least one specific region from the two-dimensional map including the point cloud, the processor selects a first line segment and a second line segment orthogonal or substantially orthogonal to a straight line extending in a normal direction from a midpoint of the first line segment, the point cloud being outside of a space between the first line segment and the second line segment, as the one pair of line segments among the plurality of line segments.

9. The device according to claim 1, wherein when selecting the at least one specific region from the two-dimensional map including the occupied grid, the processor selects a first line segment and a second line segment orthogonal or substantially orthogonal to a straight line extending in a normal direction from a midpoint of the first line segment, a free space being present between the first line segment and the second line segment, as the one pair of line segments among the plurality of line segments.

10. The device according to claim 1, wherein when selecting the at least one specific region from the two-dimensional map including the point cloud, the processor selects a first line segment from the plurality of line segments; and
when the point cloud is not present in a normal direction from a midpoint of the first line segment, the processor determines a region extending from the first line segment in the normal direction as the specific region.

11. The device according to claim 1, wherein when selecting the at least one specific region from the two-dimensional map including the occupied grid, the processor selects a first line segment from the plurality of line segments; and
when only a free space is present in a normal direction from a midpoint of the first line segment, the processor determines a region extending from the first line segment in the normal direction as the specific region.

12. A control system that controls a mobile body including an external sensor, the control system comprising:
a processor;
a memory that stores a computer program executable by the processor; and
a storage device storing data of a two-dimensional map including a point cloud or a plurality of occupied grids; wherein
the storage device stores additional data that is one or a plurality of line segments extracted from the two-dimensional map, the additional data indicating a position on the two-dimensional map in at least one specific region selected from at least one region defined by the point cloud or the plurality of occupied grids on the two-dimensional map or at least one region defined by at least one pair of line segments;
according to a command of the computer program, the processor performs:
reading the data and the additional data of the two-dimensional map from the storage device;
acquiring scan data of a surrounding environment of the mobile body from the external sensor; and
performing self-position estimation by matching the scan data with the data; and
according to a command of the computer program, the processor performs at least one of:
causing the mobile body to make a detour around the at least one specific region;
decreasing a moving speed of the mobile body before the mobile body enters the at least one specific region;
decreasing or increasing the moving speed of the mobile body after the mobile body enters the at least one specific region; and
outputting a warning signal before or after the mobile body enters the at least one specific region.

13. A mobile body comprising:
the control system according to claim 12;
the external sensor; and
a drive device to provide movement.

14. A method implemented on a computer to process map data used in self-position estimation of a mobile body including an external sensor, the method comprising:
reading the data from a storage device storing data of a two-dimensional map including a point cloud or a plurality of occupied grids;
extracting from the two-dimensional map one or a plurality of line segments defined by the point cloud or the plurality of occupied grids on the two-dimensional map;
selecting at least one specific region from at least one region included in the one or the plurality of line segments or at least one region defined by at least one pair of line segments; and
associating additional data indicating a position of the specific region on the two-dimensional map with the data.

15. A method implemented on a computer to control a mobile body including an external sensor, the method comprising:
reading data of a two-dimensional map and additional data from a storage device;
acquiring scan data of a surrounding environment of the mobile body from the external sensor; and
performing self-position estimation by matching the scan data with the data; wherein the additional data includes a plurality of line segments extracted from the two-dimensional map and indicates a position on the two-dimensional map in at least one specific region selected from at least one region defined by a point group or a plurality of occupied grids on the two-dimensional map or at least one region defined by at least one pair of line segments; and
the method further includes:
performing at least one of causing the mobile body to make a detour around the at least one specific region;
decreasing a moving speed of the mobile body before the mobile body enters the at least one specific region;
decreasing or increasing the moving speed of the mobile body after the mobile body enters the at least one specific region; and
outputting a warning signal before or after the mobile body enters the at least one specific region.
